(19) United States
(12) Patent Application Publication
(10) Pub. No.: US 2012/0061049 A1
(43) Pub. Date: Mar. 15, 2012

(54) System and Method for Delivering Temperature-Controlled Airflow Through Vending Module

(76) Inventors: Michael S. Micucci, Hyde Park, NY (US); Stephen L. Sharp, Germantown, NY (US); Alexander J. Sharp, Hyde Park, NY (US); Gil R. Tatarsky, Kingston, NY (US); John A. Thompson, Poughkeepsie, NY (US)

(21) Appl. No.: 12/983,086

(22) Filed: Dec. 31, 2010

Related U.S. Application Data
(60) Provisional application No. 61/381,149, filed on Sep. 9, 2010.

(51) Int. Cl. F24F 7/007; A61H 1/00; F25B 29/00

(52) U.S. Cl. 165/59; 165/63; 165/64; 601/49

(57) ABSTRACT

A cooling and/or heating system is provided that may include an air conditioning and heat pump assembly (refrigerant-based) housed within an enclosure. Ducts are provided to deliver air cooled by the air conditioning unit or air heated by the heat pump to one or more users positioned in the enclosure. A reversing valve is provided for directing the flow of pressurized refrigerant to one of the condenser and evaporator. When operated in heating mode, the refrigerant flow is reversed by the reversing valve and heated air is delivered through the same duct work. The air conditioning and/or heat pump assembly is controlled by a vending module to be operated by a user. The system is particularly well suited to include the sale of secondary retail and information services and items at populated public locations, e.g., a beach, city street and parks, and at other venues, e.g., theme parks, golf courses, concerts, ski slopes or other sports venues or indoor facilities such as subway stations, adult night clubs, college bars or airports.

### CROSS-REFERENCE TO RELATED APPLICATIONS

This application is based on and claims the benefit of U.S. Provisional Application No. 61/381,149, filed Sep. 9, 2010, the content of which is incorporated by reference herein in its entirety.

### BACKGROUND

1. Technical Field

The present disclosure relates to systems and methods for delivering temperature-controlled airflow and, more particularly, to personalized systems and methods whereby cooled and/or heated air may be delivered to an individual and/or group of individuals in connection with vending module(s). The disclosed temperature-controlled air-delivery stations are suitable for personal use to provide relief from hot and/or cold conditions in a variety of locations and venues. The disclosed systems/methods may include one or more associated features and functionalities, e.g., vending and/or display features that offer users simultaneous access to information and/or network communications and/or personal comforts (e.g., video displays, interactive information displays, food/beverage vending, massage and other physical comforts, music selection/feed, photographic functionalities, and the like), thereby making the systems/methods particularly suitable and advantageous for use at a wide variety of populated public and private facilities, locations and venues. Indeed, the disclosed systems and associated methods may be utilized in both indoor and outdoor settings to deliver “on-demand” cooling and/or heating environments, e.g., when sources of cooling and/or heating are otherwise unavailable or insufficient.

2. Background Art

Activities and attendance at public and private locations, facilities and events, such as theme parks, golf courses, country clubs, sporting events, beaches, city streets, county fairs, flea markets and the like, are popular. Often, the experience is made uncomfortable and potentially unhealthy by hot or cold weather. When confronted with uncomfortable/unhealthy conditions, one option is to venture into shelter to avoid the unpleasant weather. However, this option is not always available, e.g., when attending a baseball game or concert at an outdoor stadium, or when at the beach for the day. In addition, if people are enjoying their time at a park or sporting event, the fun may be diminished by the hot or cold conditions. Also, populated indoor locations, e.g., subway stations, night clubs, college bars and airports, might not offer the proper and/or requisite sources of cooling and/or heating to satisfy the needs of individuals who are present.

Potential solutions for campers when temperatures are particularly hot are shown in U.S. Pat. No. 5,685,165 to Bigelow, Jr., and U.S. Pat. No. 7,246,505 to Navedo et al. In the Bigelow '165 patent, a portable air conditioning system is provided that includes a cover that is adapted to mount with respect to a typical insulated cooler. A fan is provided according to the Bigelow '165 patent for circulating air that passes over a cold medium, e.g., water/ice stored within the insulated cooler. The Navedo '505 patent includes a heat transfer tower configured to transfer heat located within a cooler to an area within a cooling lid. A heat sink is provided at the top of the heat transfer tower and at least partially within the cooling lid. A fan draws air into the cooling lid, across the heat sink, and out of the cooling lid. The cooled air may then be used for cooling of a tent or other compartment, for example, or may be directed to blow on an individual.

Other personalized heating and cooling systems disclosed in the patent literature include enclosed booths that can accommodate a small number of people, e.g., as disclosed in U.S. Pat. No. 5,479,787. For example, a kiosk for human occupants is disclosed in U.S. Pat. No. 4,835,983 for a walk-in ATM, including heating and cooling with ducting to maintain the ATM at its normal operating temperature.

Another noteworthy phenomena is the “oxygen bar” concept that started in the 1990s in Japan and spread to California/Las Vegas. [http://www.wikidoc.org/index.php/Oxygen_bar] Used for health and recreation, oxygen bars can now be found in many indoor venues, such as nightclubs, salons, spas, health clubs, resorts, tanning salons, restaurants, coffee houses, bars, airports, ski chalets, yoga studios, chiropractors and casinos. Oxygen bars are also offered as attractions/activities at indoor trade shows, conventions and corporate meetings, as well as at private parties and promotional events. At a typical oxygen bar, guests will pay a fee (e.g., one dollar per minute) to inhale an increased percentage of oxygen compared to the normal atmospheric content of 21% oxygen. This oxygen is produced from the ambient air by an industrial (non-medical) oxygen concentrator and “inhaled” through a nasal cannula, e.g., for a period of 5 to 10 minutes or even longer. Individual flavored scents may be added to enhance the experience. The flavors in an oxygen bar come from bubbling oxygen through bottles containing aromatic solutions before it reaches the user, e.g., using food-grade particles or aroma oils to produce the scent. [Drahl, Carmen. “The Highs and Lows of Oxygen.” C&EN 86.45 (2008):64]

In summary, while there are a wide variety of devices and/or techniques available to provide a person with some environmental relief from hot and/or cold weather or conditions, it is nonetheless desirable to provide personal heating and/or cooling vending systems and methods that are adapted for “on-demand” use in a wide variety of populated public and private outdoor and indoor locations, facilities, sites and venues.

### SUMMARY OF THE DISCLOSURE

Generally speaking, in accordance with the present disclosure, cooling and/or heating systems and methods are provided that are adapted for personal use. Exemplary embodiments of the present disclosure include temperature control equipment, e.g., equipment that is adapted to cool air, warm air or both, for on-demand delivery to users of the disclosed systems and methods. Thus, in an exemplary implementation, an air conditioning and heat pump assembly (refrigerant-based) is provided for personalized delivery of cooled or heated airflow. Although exemplary embodiments of the present disclosure embody an ability to deliver both cooled and heated airflow, the present disclosure is not limited by or to such implementations. Rather, the present disclosure expressly encompasses implementations wherein either cooling or heating temperature-control functionality is provided, e.g., for use in environments where only cooling or heating is generally required.

According to exemplary embodiments of the present disclosure, the temperature-control equipment (i.e., equipment that is adapted to deliver cooled airflow, heated airflow or both) is generally housed within or otherwise associated with an advantageous enclosure or station. The disclosed system/unit generally includes one or more ducts and/or ducting systems that are adapted to deliver cooled air, e.g., air cooled by an air conditioning unit, heated air, e.g., air heated by a heat pump, or both cooled air and heated air, to one or more users positioned in or at an appropriate cooling/heating region or location. In exemplary implementations, the air conditioning and/or heat pump assembly is mounted on a frame within a cover/housing and controlled—“on-demand”—by a vending module that is adapted for operation by one or more users.

Exemplary vending modules according to the present disclosure are generally adapted and/or programmed to allow delivery of cool and/or warm air to an appropriate cooling/heating region or location associated with the system/unit for a predetermined period of time in response to deposit of a predetermined payment, e.g., two minutes for five dollars. The vending module may be adapted to accept payment by cash, credit card, debit card or the like. In an alternative exemplary implementation, a predetermined number of uses of the disclosed system/unit may be included in the “admission price” for a venue/facility. In such exemplary implementation, the vending module may be adapted to accept “vouchers” provided by the venue/facility, with appropriate payment to an operator of the disclosed system/unit being established between the venue/facility and the operator based on such voucher-based operation. Thus, the vending unit of the present disclosure may have the ability to permit delivery of cooled air only, heated air only, or cooled and heated air through the same ducting, depending on the nature of the cooling and/or heating equipment associated with the disclosed system/unit.

The disclosed system/unit may be designed to provide both cool air and heated air through an advantageous duct work system, as noted previously, it is expressly contemplated that the disclosed system/unit may instead be set up to dispense cool air only or warm air only. In implementations where dual temperature control is supported (i.e., both cooled and heated airflow), the mode of operation (i.e., heating or cooling operation) is generally selected by the user (or users), thereby benefiting from the dual heating/cooling design of such implementation of the present disclosure. Of note, “toggling” between cooling and heating operation may be achieved with ease and within a few seconds. This is useful in many situations/implementations, e.g., locales/venues where it is hot during the day and cool at night (i.e., August days/nights in New York and many desert climates), locales/venues in mild/warm/hot climates where individuals may also desire to dry off/warm up when getting out of cold water at a theme park, beach, or other venue/location where there is water and at a locales/venues where the climate is hot part of year and cold another part (e.g., a stadium where both baseball and football games are played). The refrigeration and heating equipment design may be based on existing cooling and heating units, but such cooling/heating equipment is advantageously adapted to operate in conjunction with air distribution and electronic control systems to enable the system/unit to deliver cool and warm air “on-demand” by end user(s).

The overall design and operation of the disclosed personal cooling and/or heating system are particularly well suited to be located at popular locations, facilities and venues, such as a beach, city street, theme or other park, golf course, country club, county fair, flea market, concert facility/venue, ski slope or other sports venue and indoor locations such as a subway station, night club, college bar and airport. The system and unit can be powered by a variety of power sources as described below. The disclosed system/unit may be associated with wheels so as to permit repositioning and/or removal. In addition, the disclosed system/unit may be modular in design, whereby efficient assembly and disassembly may be achieved for repositioning, maintenance and/or transport thereof.

Accordingly, it is an object of the invention to provide a system and method for delivering cooling and/or heating airflow to user(s).

Another object of the invention is to provide a cooling and/or heating system and method that is self contained and powered by an effective energy source, e.g., one or more energy sources selected from among various renewable and non-renewable energy sources.

A further object of the invention is to provide a cooling and/or heating system and method that includes, inter alia, a vending module/functionality that is adapted to control access and/or delivery of temperature-controlled airflow on-demand to user(s).

Another object of the invention is to provide a cooling and/or heating system and method that is adapted to distribute and/or dispense cooled and/or heated air through associated duct work.

Yet another object of the invention is to provide a cooling and/or heating system and method that includes, inter alia, a display screen associated with the system/unit, e.g., mounted and/or attached with respect to a top, side, front or back surface or interior of the disclosed system/unit.

Yet a further object of the invention is to provide a cooling and/or heating system and method that is portable and can be used in a wide variety of populated outdoor and indoor locations, such as beaches, city streets, subway stations and outdoor sports and entertainment venues.

Still another object of the invention is to provide a cooling system wherein condensation formed during operation may be utilized, in whole or in part, for irrigation of the surrounding environment.

A further object of the invention is to provide a system/unit that may include, inter alia, an associated comfort and/or therapeutic component, e.g., an automatic massage chair, a chair, table or surface that accommodates massage, acupuncture or other comfort-related or therapeutic-related activity, a vibratory chair/mechanism, a decompression chair/mechanism or the like.

A still further object of the invention is to provide a system/unit that may be used, inter alia, in conjunction with associated comfort and/or therapeutic services, e.g., massage, acupuncture, chiropractic, decompression or the like.

Still further objects of the invention include cooling and/or heating systems that include one or more of the following features and/or functionalities: (i) LED lighting or other illumination for visibility at night; (ii) handicap accessibility; (iii) advantageous structural features and functions, e.g., one or more steps, hand rails, seating areas; canopies, curtains, ceilings, walls and/or doors; (iv) extended personal/flexible ducting that extends anywhere to/from the system/unit; (v) one or more currency collectors/vending units or modules; (vi) vent and return air functionality that supports desired airflow pattern(s), e.g., from top of unit to bottom of unit, from bottom of unit to top of unit, from one side of unit to other side of unit, from one or both sides of unit to back of unit, etc.; (vii) user control of airflow parameters, e.g., functionality that allows a user to regulate airflow rate; (viii) user control of airflow temperature, e.g., functionality that allows a user to regulate the temperature at which cooled and/or heated air is delivered/dispensed; (ix) the system/unit includes a housing fabricated from one or more materials, e.g., aluminum, metal, steel, wood, plastic, stainless steel, glass, plexi-glass, or any other type of non-composite material, cast iron, tin, copper, and combinations thereof; (x) LED or other advertising display screen(s) attached or mounted with respect to the system/unit, including double-sided monitor(s) mounted with respect to the interior and/or exterior of the system/unit; (xi) interactive media, video games and/or Internet access housed and/or otherwise associated with the system/unit; (xii) system/unit can be designed for use by groups or individuals, e.g., multiple cooling and/or heating units may be positioned within a tent or other facility for group use; (xiii) system/unit may include multiple coils and evaporators supplied by one or more compressors; (xiv) system/unit may include audio functionality; (xv) system/unit may be portable or a permanent fixture; (xvi) system/unit may include, in whole or in part, a weatherproof exterior; (xvii) system/unit may include various aesthetic appearances, e.g., various interior and/or exterior colors, shapes, sizes, styles and the like; (xviii) system/unit may be adapted to display fixed and/or variable advertisements and/or promotions; (xix) system/unit may include an ability to filter and/or augment/supplement the airflow with scents, aromas/aroma therapy, ionization and the like; (xx) system/unit may have the ability to link to a business to make direct consumer purchases (e.g., “virtual” home shopping) or play direct response commercials linking to the marketer for purchase; (xxi) system/unit may include, inter alia, functionality to dispense, supply and/or vend food and/or beverages; and/or (xxii) system/unit may include, inter alia, functionality for photographing purposes, e.g., a photo booth to take family photos while people are cooling off and/or warming up.

Still other objects and advantages of the invention will in part be obvious and will in part be apparent from the specification.

The invention comprises systems and methods possessing the features, properties, functionalities and/or the relation of components which will be exemplified in the embodiments/implementations hereinafter described and the scope of the invention will be indicated in the claims appended hereto.

### BRIEF DESCRIPTION OF THE DRAWINGS

For a fuller understanding of the invention, reference is had to the following description taken in connection with the accompanying drawings, in which:

FIG. 1 is a perspective view of an exemplary cooling and/or heating system constructed and arranged in accordance with an implementation of the disclosed invention;

FIG. 2 is left side elevational view of the exemplary cooling and/or heating system of FIG. 1 shown with a user in position;

FIG. 3 is a front elevational view of the exemplary cooling and/or heating system of FIGS. 1 and 2;

FIG. 4 is a front view of another exemplary embodiment of a cooling and/or heating system constructed and arranged in accordance with an implementation of the disclosed invention;

FIG. 4A is a side view of the exemplary cooling and/or heating system of FIG. 4 (with display monitor 44 removed) that illustrates, inter alia, a cooling and/or heating region to be occupied by a system user;

FIG. 5 is a right front perspective view of the illustrative housing/cover associated with the exemplary cooling and/or heating system of FIGS. 4 and 4A;

FIG. 6 is a right rear perspective view of the illustrative housing/cover of FIG. 5;

FIG. 7 is a perspective view of an exemplary handrail for use in association with the exemplary cooling and/or heating system of FIG. 4;

FIG. 8 is a front elevational view of an exemplary implementation of the cooling and/or heating system of FIG. 4, wherein a cover panel of the housing/cover is removed to show various components for delivering both cooling and heating airflow to a user according to an exemplary implementation of the present disclosure;

FIG. 9 is a right side elevational view of the exemplary cooling and heating system of FIG. 8;

FIG. 10 is a perspective view of exemplary ductwork for airflow delivery according to the cooling and heating system of FIGS. 8 and 9;

FIG. 11 is a schematic illustration of an exemplary cooling mode cycle according to the present disclosure, e.g., a cooling mode cycle for implementation with the exemplary cooling and heating system of FIGS. 8 and 9 constructed and arranged in accordance with an illustrative implementation of the disclosed invention;

FIG. 12 is a schematic illustration of an exemplary heating mode cycle according to the present disclosure, e.g., a heating mode cycle for implementation with the exemplary cooling and heating system of FIGS. 8 and 9 constructed and arranged in accordance with an illustrative implementation of the disclosed invention; and

FIG. 13 is a schematic drawing of exemplary wiring diagram suitable for use with the cooling and heating system of FIGS. 8 and 9.

### DESCRIPTION OF EXEMPLARY EMBODIMENT(S)

As noted above, the present disclosure provides an advantageous cooling and/or heating system/unit that is adapted to deliver temperature-controlled airflow to one or more system users through a vending module. The present disclosure further provides advantageous methods for delivering temperature-controlled airflow to one or more users. In exemplary implementations of the disclosed system/method, the present disclosure provides cool airflow, warm airflow or both cool airflow and warm airflow, e.g., based on an air conditioning and heat pump assembly (refrigerant-based) housed within or otherwise associated with an advantageous housing, enclosure and/or station. A ducting system is also provided to deliver air cooled by the air conditioning unit and/or air heated by the heat pump to one or more users positioned in or at an appropriate cooling/heating region or location.

Delivery of cooled air and/or heated air is controlled by an end user “on-demand” and requires user interaction with a vending module to enable operation thereof, e.g., based on an appropriate payment. Thus, in such exemplary implementations, the vending module is generally adapted/programmed to deliver cool and/or heated air for a predetermined period of time in response to deposit of a predetermined payment. The vending module may be adapted to accept payment by cash, credit card, debit card or the like. Exemplary implementations of the present disclosure encompass multiple systems/units at distinct locations, e.g., distinct locations at a single site (e.g., an amusement park, beach, coliseum/stadium or the like), distinct locations at distinct sites (e.g., one or more systems/units may be located at geographically distinct amusement parks, beaches, coliseums/stadiums and the like), and combinations thereof. In such multiple system/unit implementations, it is contemplated that a universally accepted payment card/device may be provided that facilitates payment for use of the disclosed systems/units on a network-wide basis. Thus, in the same way that a “Metro Card” or “E-Z Pass” system operates, the multiple system/unit implementations may accommodate central processing of payments for use of the disclosed systems/units, thereby enhancing efficiency and convenience.

In an alternative exemplary implementation, a predetermined number of uses of the disclosed system/unit may be included in the “admission price” for a venue/facility as to help reduce potential health issues as heat stroke or for any other purpose. In such exemplary implementation, the vending module may be adapted to accept “vouchers” provided by the venue/facility, with appropriate payment to an operator of the disclosed system/unit being established between the venue/facility and the operator based on such voucher-based operation.

Thus, in exemplary implementations of the present disclosure, the disclosed vending module includes a first functionality to receive and process payment from a system user, and a second functionality that, based upon receipt and processing of such payment, operates to either activate or allow activation of the associated apparatus for generating and delivering cool air and/or warm air. The second functionality generally includes programming that limits the generation and delivery of cool and/or warm air to a preset period of time based on the magnitude of the payment received. Actual operation of the associated apparatus for generating and delivering cool air and/or warm air may commence immediately upon receipt and processing of payment by the vending module or may await initiation by the end user, e.g., based upon end user interaction with a control panel.

The disclosed system/unit and method generally provides cool air and/or warm air through an advantageous duct work system. Thus, in implementations where both cool air functionality and heated air functionality are provided, the disclosed system/method advantageously operates with or through the same duct work for both functionalities. The mode of operation of the disclosed system/unit (i.e., heating or cooling operation) is generally selected by the user (or users), thereby benefiting from the optional dual heating/cooling design of the present disclosure. Of note, “toggling” between cooling and heating operation may be achieved with ease and within a few seconds. This dual functionality may be useful in many situations, e.g., locales/venues where it is hot during the day and cool at night, locales/venues in mild/warm/hot climates where individuals may also desire to dry off/warm up when getting out of cold water at a theme park, beach, or other venue/location where there is water, and at a locales/venues where the climate is hot part of year and cold another part. The refrigeration and heating equipment design may be based on existing cooling and heating units, but such cooling/heating equipment is advantageously adapted to operate in conjunction with air distribution and electronic control systems to enable the unit to deliver cool and warm air “on-demand” by end user(s).

Exemplary embodiments of the disclosed personal cooling and/or heating vending system/unit may include one or more additional features and/or functionalities. Thus, for example, the disclosed system/unit may include one or more information displays and/or monitors, e.g., flat panel LCD and/or LED displays or other advertising display indicia (e.g., billboards, electronic signs and the like). Information displays/monitors may be associated with the disclosed systems/units in various ways, e.g., one or more displays/monitors may be attached to or otherwise associated with the top, side(s), front and/or back surfaces of the system/unit (e.g., one or more of the top, side(s), front or back faces of the enclosure and/or station). The disclosed displays/monitors may be interactive so as to allow, for example, a user to play video games, access the internet, view television programming, view activities “in real time” that are occurring elsewhere at the venue/facility, and the like, while simultaneously benefiting from the “on-demand” delivery of cool or warm air. In addition, exemplary embodiments of the disclosed system/unit may be configured to support use by only a single user, or simultaneous use by multiple users—whether in/at the same enclosure/station or in/at individual pods or stations that receive desired levels of cooling and/or heating air flow.

Moreover, the disclosed system/unit may be adapted to operate based on a variety of energy sources. For example, the heating and/or cooling unit may be powered by energy supplied by water, electricity, fuel, oil, gas, solar, geothermal, propane, flex fuel, diesel, battery power, chilled water coil and/or combinations thereof. With respect to solar energy, the disclosed system/unit may advantageously include one or more solar energy collectors at appropriate locations to collect solar energy. Indeed, the disclosed system/unit may be connected to an energy grid, e.g., the energy supply system supplying the venue/facility at which the system/unit is located, and excess solar energy may be fed to such grid or otherwise resold or bartered with an appropriate utility host provider.

To facilitate use at various times and in various settings/conditions, the disclosed system/unit may be provided with LED lighting or other illumination, e.g., to provide visibility at night, or otherwise support safety and utility thereof. The enclosure/station associated with the disclosed system/unit and the associated entry/egress paths to such enclosure/station are generally handicap accessible. Recharging of user equipment, e.g., electric/battery-operated wheel chairs, portable phones/computers/PDA's and the like, may be offered within the enclosure and/or at the station and may include associated “vending” functionality.

The housing, enclosure and/or station associated with the disclosed system/unit may include and/or be associated with various features and/or structures. For example, the disclosed housing/enclosure/station may include and/or be associated with one or more steps to facilitate ingress/egress, one or more hand rails to facilitate safety of use, one or more seating areas to accommodate user(s), and a vending device/currency collector unit. One or more privacy canopies and/or curtains may be provided in connection with the housing/enclosure/station, e.g., to provide discrete and/or personal regions/areas within or otherwise associated with the housing/enclosure/station for use by individuals and/or groups of individuals. Any number of units may be housed in a tent area, building or other enclosure to provide a secure and convenient location for multiple users to simultaneously benefit from the cool and/or heated airflow associated with the disclosed systems/methods. Thus, in such multiple unit implementations, a plurality of individuals are allowed to simultaneously take a break and/or renew themselves from the heat or cold (e.g., in an arcade-type environment).

The disclosed system/unit and method may also be adapted to provide any number of individualized jets or air flow supply for use and control by individuals. For example, extended personal, flexible ducting may be provided that permits an individual to direct a flow of cool or warm air to a particular anatomic location/region, e.g., for directing warm air to an individual's feet, cool air to an individual's neck region, and the like. The personal ducting may also be utilized by parents to direct cool/warm air to chilled and/or over-heated children in a concentrated manner.

From an airflow standpoint, exemplary embodiments of the present disclosure may be adapted to draw in and exhaust air in a variety of ways. For example, airflow may be designed such that air enters the system/unit at the top of the housing/enclosure/station and flows toward the bottom of the housing/enclosure/station. Alternatively, the airflow may be designed such that cooled/heated air is expelled from the housing/enclosure/station from one or more sides and/or back of the housing/enclosure/station and is exhausted from the top, bottom or an opposite side. Indeed, it is contemplated according to the present disclosure that cooled/warmed air may enter the housing/enclosure/station in virtually any location, e.g., through/from one or more steps, hand rails, seating areas, canopies, curtains, ceilings, walls and/or doors, and/or through extended personal, flexible ducting. Valving and/or manifolding may be provided that permits users to select a desired airflow arrangement, thereby providing greater flexibility and personalization in the operation of the disclosed system/unit.

In addition, it is contemplated that the airflow may be augmented and/or treated, e.g., by way of scents, aroma therapy, ionization and the like. In implementations that include such airflow augmentation and/or treatment, appropriate means are generally provided for introduction of desired augmentation/treatment, e.g., based on user request/selection. Exemplary means include metering systems for introducing atomized scents and/or aroma therapy constituents to the airflow system and/or ionization apparatus that is positioned and adapted to ionize airflow (in whole or in part) associated with the disclosed system/method. Vending functionality may be advantageously associated with such airflow augmentation/treatment, such that users electing to receive augmented and/or treated airflow are required to make a predetermined payment for receipt thereof.

With reference to cooling and heating parameters, the disclosed system/unit may be adapted to provide user control of the operating parameters associated with the airflow (or control of such parameters may be reserved to the manager of the disclosed system/unit). Thus, according to exemplary embodiments of the present disclosure, the user may have control over such operating parameters as the airflow rate to the housing/enclosure/station, the airflow temperature to the housing/enclosure/station, the target temperature within/at the housing/enclosure/station, and the like.

The disclosed system/unit, including specifically the associated housing/enclosure/station, may be fabricated from conventional materials. For example, the exterior of the system/unit may be fabricated from such materials as aluminum, steel, stainless steel, cast iron, tin, copper or other metal, glass, plexi-glass, wood, plastic or any other type of composite or non-composite material and/or combinations thereof. The disclosed heating unit element may employ electric heating technology. In exemplary systems for exclusive delivery of heated airflow, it is further contemplated that a ceramic heating unit may be employed. The design of the system/unit may advantageously offer weatherproof functionality to the exterior surfaces thereof. In addition, the system/unit can be made in any color configuration or in any shape or size, subject to heating/cooling equipment and user-comfort requirements and/or considerations.

With further reference to electronic accessories and/or functionalities that may be provided or otherwise associated with the disclosed system/unit, it is noted that according to exemplary embodiments of the present disclosure, the system/unit may have one or more LEDs or other advertising display screens/monitors that may be fixedly or detachably secured with respect to the top, sides, front and/or back of the system/unit and/or enclosure/station. The displays/monitors may be of any suitable size and may include one or more double-sided displays/monitors for viewing from multiple positions/orientations. The disclosed system/unit may be adapted for communication with interactive media and/or video games and/or may provide Internet access to be housed anywhere in/on the unit. Indeed, the disclosed system/unit may have the ability to link directly to a business to make direct consumer purchases (e.g., “virtual” home shopping) or to play direct response commercials linking to the marketer for purchase. In addition, the disclosed system/unit, including specifically the associated enclosure/station, may include audio capabilities and/or functionality, e.g., one or more speakers that are adapted to deliver music, announcements or the like. The speaker(s) may be positioned to deliver audio within the enclosure/station, outside the enclosure/station, or both.

From a cooling/heating perspective, exemplary embodiments of the present disclosure include multiple coils and evaporators, and such coils and/or evaporators may be supplied by one or more compressors, as appropriate for the heating and/or cooling functionality to be supplied by the specific implementation of the present disclosures. Although preferred implementations of the present disclosure are adapted to supply either cooling or heating airflow in an “on-demand” manner, the present disclosure also encompasses systems/units that are adapted to provide cooling only or heating only.

Of note, the disclosed system/unit may be provided with piping, tubing or the like to deliver condensation from the unit to a desired location, e.g., for use in irrigating vegetation or another desired purpose. The disclosed system/unit may also include air filtration functionality to purify the air being used for cooling/heating purposes. In addition, an ionizer and/or aroma therapy feed system may be associated with the disclosed system/unit so as to deliver a desired airflow to/at the housing/enclosure/station or compounds/constituents adapted to delivered to deliver a desired scent may be applied for scent delivery solutions and scent marketing purposes by the venue and/or facility owner or host. A wide range of air treatments may be employed, as will be readily apparent to persons skilled in the art, and user control of such airflow functionality may be provided, e.g., such that an end user may select “ionized” air in return for a payment premium.

In addition, the disclosed system/unit can offer various user-comfort features, such as an automatic massage chair or foot massager to permit users to receive a massage while cooling off or warming up. In exemplary implementations, the disclosed system/unit may be provided with one or more massage tables/boards so as to permit massage delivery by massage specialist(s). Indeed, the disclosed system/unit may advantageously include, inter alia, an associated comfort and/or therapeutic component, e.g., an automatic massage chair, a chair, table or surface that accommodates massage, acupuncture or other comfort-related or therapeutic-related activity, a vibratory chair/mechanism, a decompression chair/mechanism or the like. The disclosed system/unit may also be used, inter alia, in conjunction with associated comfort and/or therapeutic services, e.g., massage, acupuncture, chiropractic, decompression or the like. Still further, the disclosed system/unit may be adapted to dispense food and/or beverages, e.g., by way of conventional food/beverage vending machine functionality, and may include a water fountain or other drinking water supply. Moreover, the disclosed system/unit may be adapted to operate as a “photo booth,” thereby permitting users to take photos (e.g., a family photo) while cooling off or warming up within/at the enclosure/station. An appropriate delivery mechanism may be provided for delivering such photos to the appropriate individuals, e.g., based on payment of an appropriate fee or free as part of the cool and/or heated airflow vending operation.

The disclosed personal cooling and/or heating vending system may be employed in various settings, locations, facilities and venues, such as a beach, city street, theme or other park, golf course, country club, county fair, flea market, concert facility/venue, ski slope or other sports venue and indoor facilities such as a subway station, night club, college bar, airport and other locations. In addition, the disclosed system/unit may be associated with wheels so as to permit repositioning and/or removal. In addition, the disclosed system/unit may be modular in design, whereby efficient assembly and disassembly may be achieved for repositioning, maintenance and/or transport thereof.

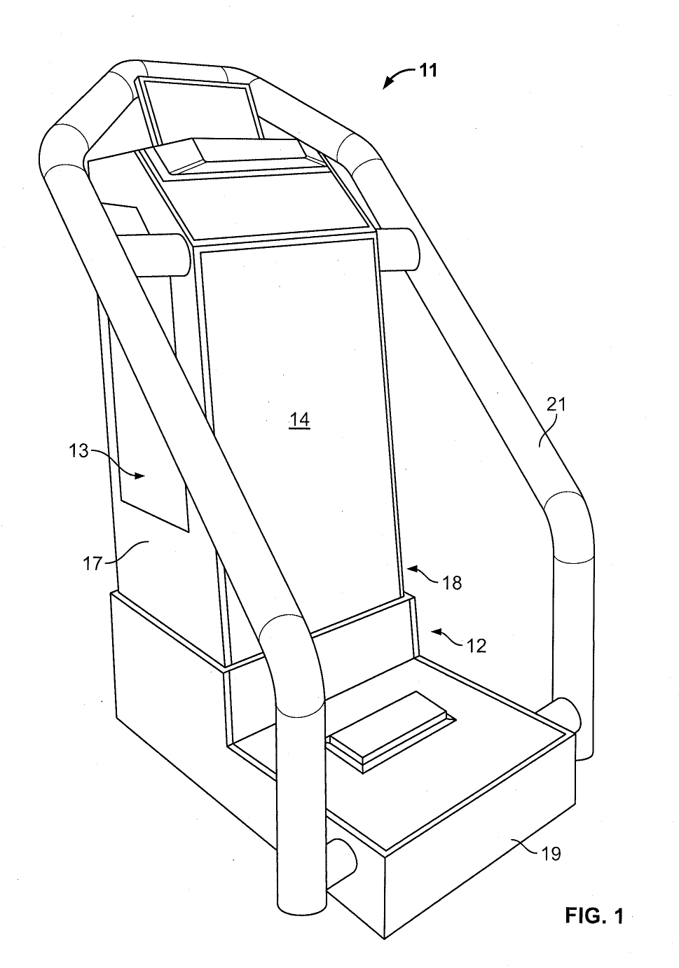

With reference to the accompanying figures, exemplary embodiments and/or implementations of the present disclosure are schematically depicted. However, it is to be noted that the present disclosure is not limited by or to such exemplary embodiments or implementations. With initial reference to FIGS. 1, 2 and 3, it is noted that such figures refer to the same exemplary embodiment of the present disclosure and are numbered consistently throughout these figures.

FIG. 1 illustrates an exemplary cooling and/or heating system/device 11 constructed and arranged in accordance with an exemplary embodiment of the invention. Thus, the exemplary implementation of FIG. 1 may be adapted to deliver cooled airflow, heated airflow or both cooled airflow and heated airflow, depending on the cooling/heating equipment provided therewith. Cooling and/or heating device 11 defines a station 12 that is adjacent a substantially rectangular housing 13 having a front side 14, a rear side 16, a left side 17 and a right side 18. In an exemplary implementation of the present disclosure, housing 13 is approximately 48 inches tall, 18 inches wide and 18 inches in depth, and includes user console panel 20 positioned on an angularly oriented face toward the top of front side 14. The dimensional parameters disclosed herein are merely illustrative, and are not limiting as to scope of the present disclosure.

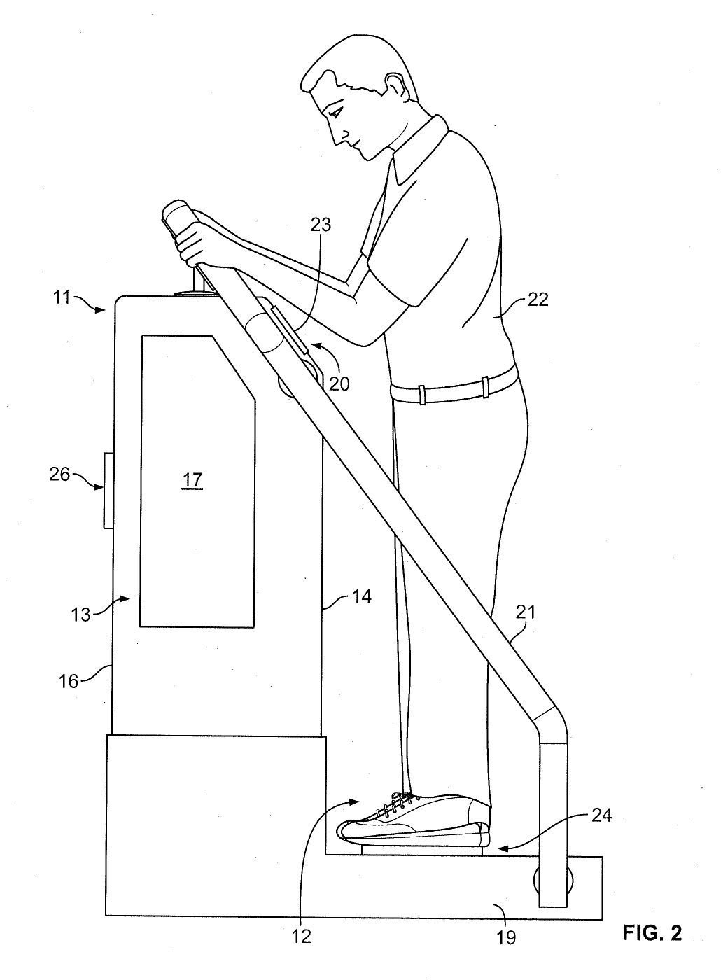

A platform 19, which in an exemplary embodiment is about six inches in height, extends in an L-shaped configuration relative to the front side 14 of housing 13. A pair of hand rails 21 are mounted at the top with respect to sides 17 and 18 of housing 13 and at the bottom with respect to the sides of platform 19, thereby enclosing station 12. A user 22 is shown in position on platform 19 in FIG. 2, i.e., at station 12, for taking advantage of the weather relief provided by cooling and/or heating device 11. Thus, in implementations of device 11 wherein only heated airflow is available, user 22 may benefit from such cooled airflow through use of the disclosed system. Similarly, in implementations of device 11 wherein only heated airflow is available, user 22 may benefit from such heated airflow through use of the disclosed system. And, in implementations where both cooled airflow and heated airflow are available, the user may benefit from either of the available airflows, i.e., cooled or heated airflow, e.g., based upon his/her selection.

As shown in FIG. 2, housing 13 includes an upper air vent 23 located on or adjacent to user console panel 20 on the angled portion of front side 14, i.e., facing toward user 22. A lower air vent 24 is provided on the upper face of platform 19, i.e., under the feet of user 22. Thus, both upper air vent 23 and lower air vent 24 direct cooled or heated air into region 12, thereby offering cooling or heating to user 22. Vents 23 and 24 are located at positions to blow cool and heated air to the upper and lower parts of user 22 to provide relief from a hot or cold environment. An exhaust vent 26 for exhausting heated or cooled air from within housing 13, depending on the comfort mode selected by the user, is located on the rear side 16 of housing 13.

As noted previously, the disclosed device 11 may be fabricated from various materials. For example, housing 13 of device 11 may be made of any suitable substantially rigid sheet material, such as sheet metal, aluminum, or a plastic. Handles 21 may be made of the same or a different material; preferably, handles 21 are formed of aluminum and, in exemplary implementations, such handles 21 may be encased (in whole or in part), e.g., in a foam material to provide an advantageous user experience.

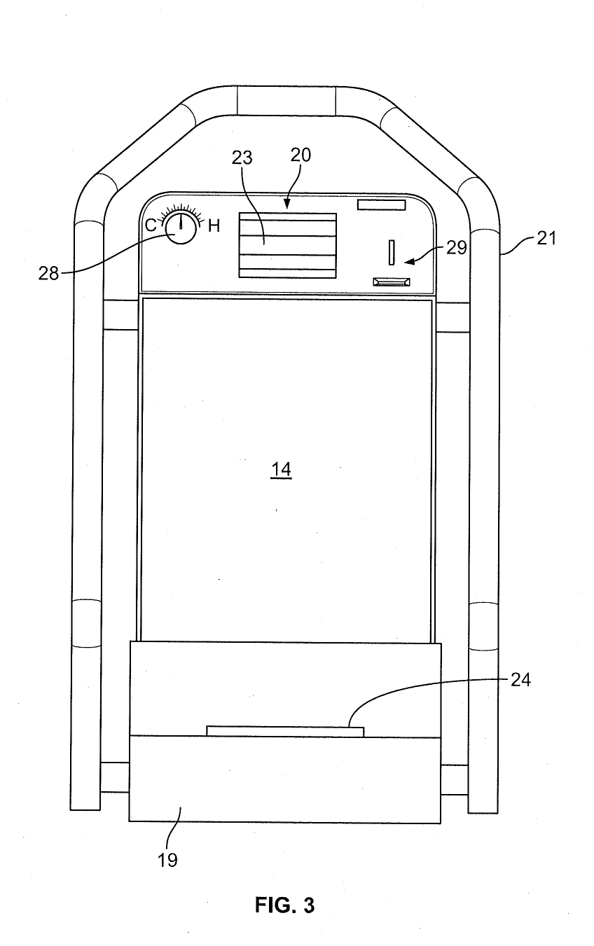

As shown in FIG. 3, device 11 includes user controls on user console panel 20 on the angled portion of front side 14 of housing 13. Exemplary controls according to the exemplary embodiment of FIGS. 1-3 include a user control/display 28 to indicate/control mode of operation (i.e., “C” for cold air and “H” for hot air). The foregoing exemplary control as between “C” and “H” modes of operation is applicable in situations where device/system 11 is adapted to provide both cool airflow and heated airflow. A vending section or module 29 is also provided on console panel 20, e.g., for receipt of coins, tokens, currency, and/or credit/debit cards, to permit an end user 22 to activate device 11. Vending module 29 generally includes a processor and/or integrated circuit that is programmed to control operation of the heating and/or cooling equipment. For example, the processor/integrated circuit is advantageously programmed or otherwise adapted to permit delivery of a predetermined period of cool air and/or heated air for a predetermined payment.

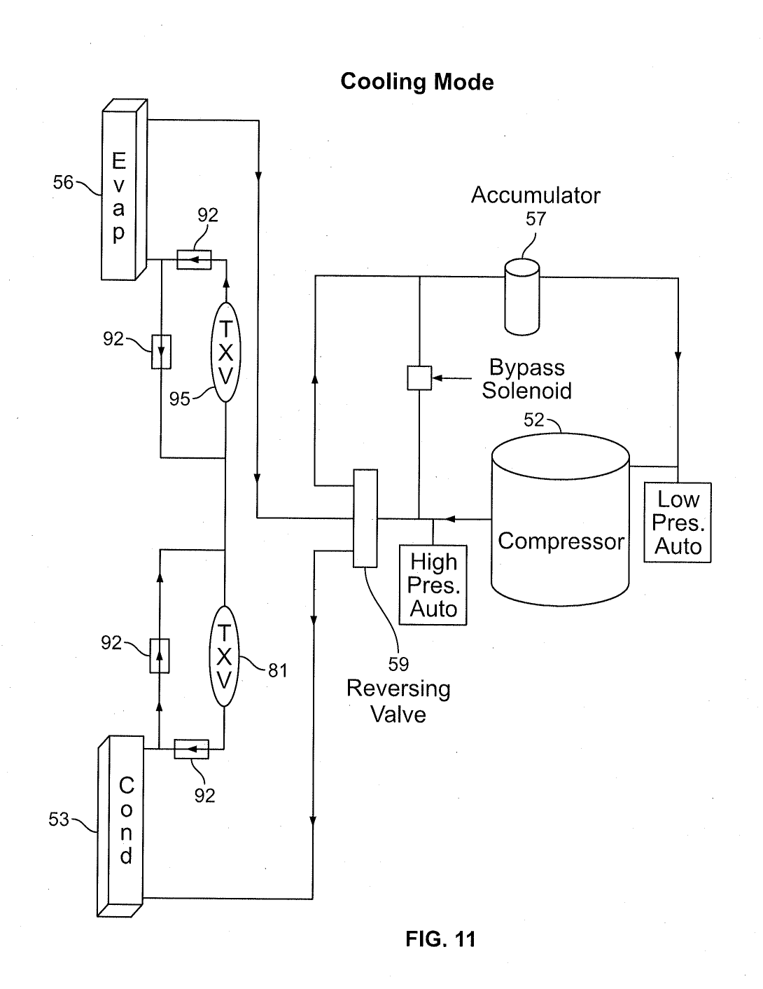

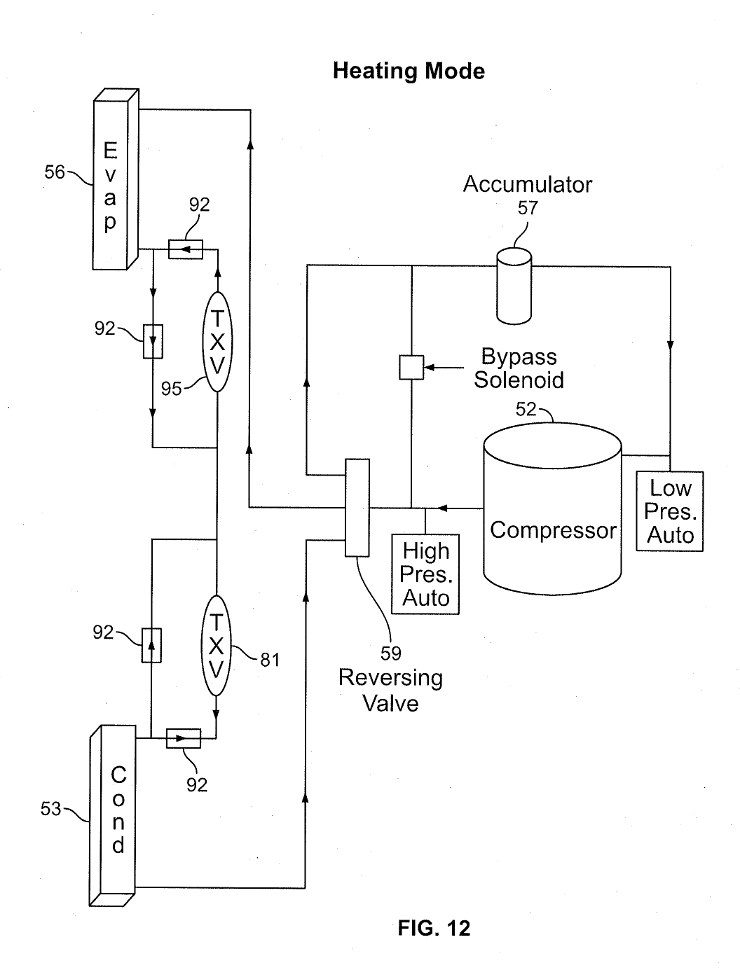

Housing 13 of device 11 includes the heating and/or cooling elements, e.g., exemplary heating and cooling elements that would operate in conjunction with the illustrative wiring schematics shown in FIGS. 11 and 12 (described below). However, as described herein, housing 13 may contain only cooling equipment or only heating equipment, based on the desired implementation of the present disclosure. In circumstances where both heating and cooling functionalities are supported by device 11, ducting is generally provided within housing 13 to facilitate both cooled airflow and heated airflow to a user, e.g., from vents 23 and 24.

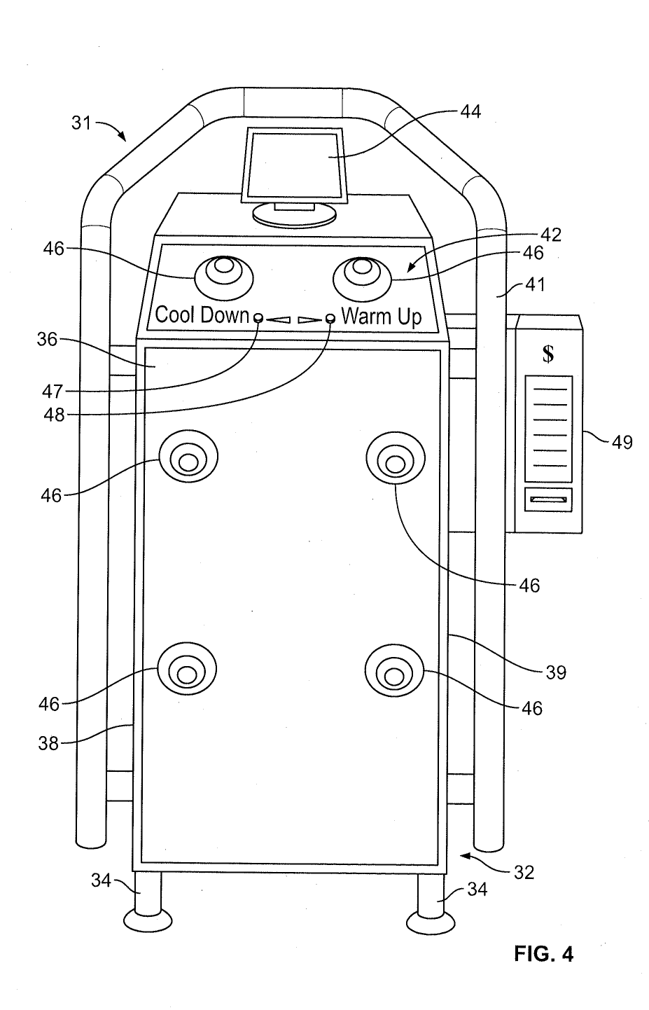

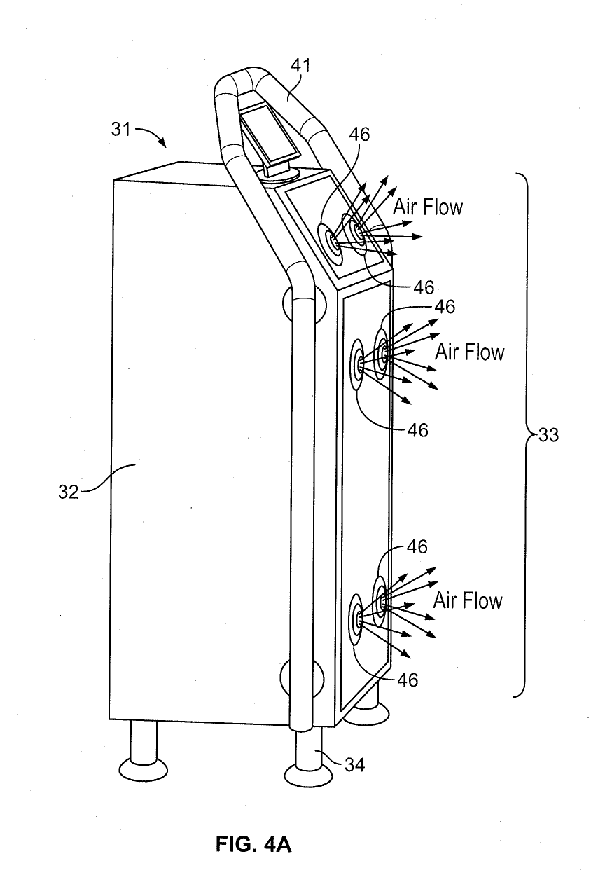

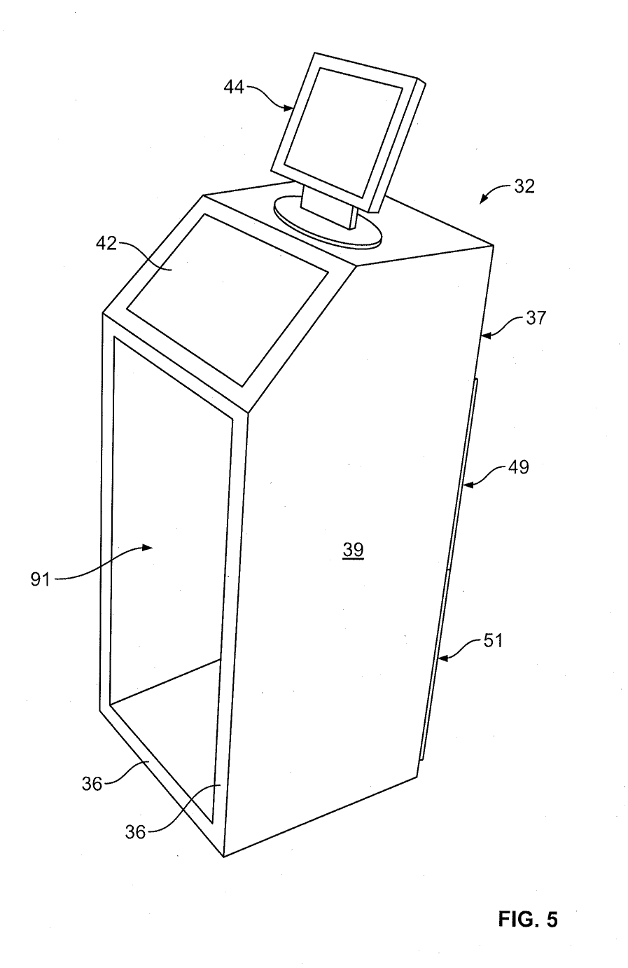

With reference to FIGS. 4-10, it is noted that such figures refer to the same exemplary embodiment of the present disclosure and are numbered consistently throughout these figures. FIG. 4 is a front view of another exemplary embodiment of a cooling and/or heating system/device 31 constructed and arranged in accordance with the present invention. Device 31 includes a housing 32 and four legs 34 to space housing 32 from a floor or ground surface. Housing 32 includes a front side 36, a rear side 37 (see FIG. 5), a left side 38 and a right side 39. A user handle 41 is mounted to left side 38 and right side 39 and extends in one piece around the upper portion of housing 32, i.e., user handle 41 is of integral construction. Of note, handle 41 may be encased (in whole or in part) by a desirable material, e.g., a foam material, to enhance comfortable interaction therewith. In addition, user handle 41 may be provided in segmented components that may be assembled to define the substantially U-shaped configuration shown in FIG. 4.

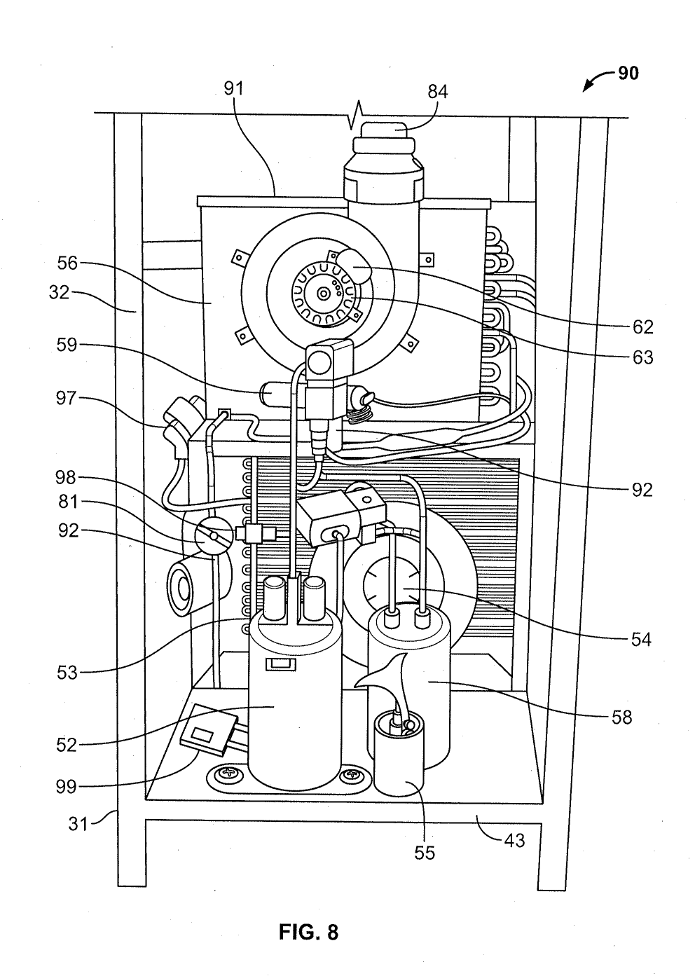

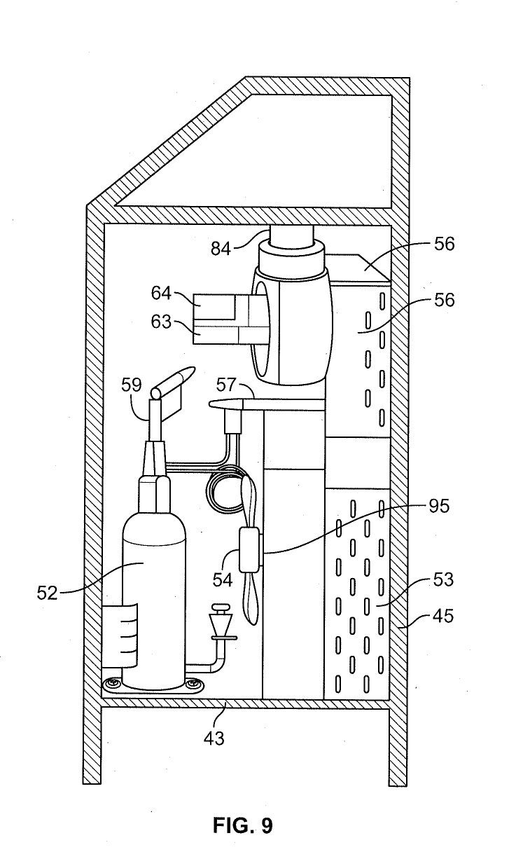

Housing 32 includes or defines a user console 42 on an upper portion thereof and defines an interior region 91 that is configured and dimensioned to receive/encase a cooling and/or heating system 90. An exemplary cooling/heating system 90 is shown in detail in FIGS. 8 and 9. However, the present disclosure is not limited by or to the exemplary cooling/heating system 90 described with reference to FIGS. 8 and 9. Rather, the disclosed system/method may be implemented with alternative cooling system components and/or alternative heating system components, and may be implemented with both cooling and heating system components or with only one or the other of such system components.

In the exemplary implementation of FIGS. 4 and 4A, housing 32 includes a plurality of air diffusers 46 for directing airflow outward from the front side 36 thereof. The number and positioning of diffusers 46 is not critical to the design and/or operation of the disclosed system/method. Rather, the present disclosure contemplates positioning of a sufficient number of diffusers 46 to provide adequate airflow to achieve the desired cooling and/or heating functionality described herein. In the exemplary embodiment of FIGS. 4 and 4A, six (6) air diffusers 46 are mounted with respect to the front side 36 of housing 32—two diffusers 46 are mounted with respect to an angled portion of front side 36 (toward the top of housing 32), i.e., on or adjacent console 42, to provide cool/heated airflow to a user's face and/or upper body, and an additional four (4) diffusers 46 are mounted on the vertical portion of front side 36 of housing 32 to provide cool/heated airflow to a user's torso and upper/lower body. Air diffusers 46 may be directionally adjustable so that a user can conveniently direct cooled or heated air in any direction, and can be adjusted to control the velocity of air coming from each said diffuser to obtain maximum relief from the environment.

Thus, as noted herein, the depiction of four diffusers 46 on the vertical portion of front side 36 and two additional diffusers 46 on the angled portion of front side 36 is non-limiting in that more or less diffusers may be employed, as will be readily apparent to persons skilled in the art. The diffusers 46 deliver cool air or heated air (depending on the available and/or selected mode of operation) to a user positioned in region 33 (see FIG. 4A), i.e., the region immediately facing diffusers 46, thus allowing device 31 to provide sufficient cooled or heated air without the need to have a cooling/heating platform (as shown in the embodiment of FIGS. 1-3). Of note, the exemplary region 33 of FIG. 4A is substantially unbounded, i.e., region 33 is defined by the directional airflow from diffusers 46. However, it is to be understood that region 33 may be bounded, in whole or in part, e.g., by one or more curtains, walls, canopies, panels and the like, such that airflow from diffusers 46 is not allowed to dissipate to the surrounding environment without restriction. In this way, region 33 may be partially or fully encompassed within an enclosed area to capture the cooled or heated air delivered thereto from diffusers 46.

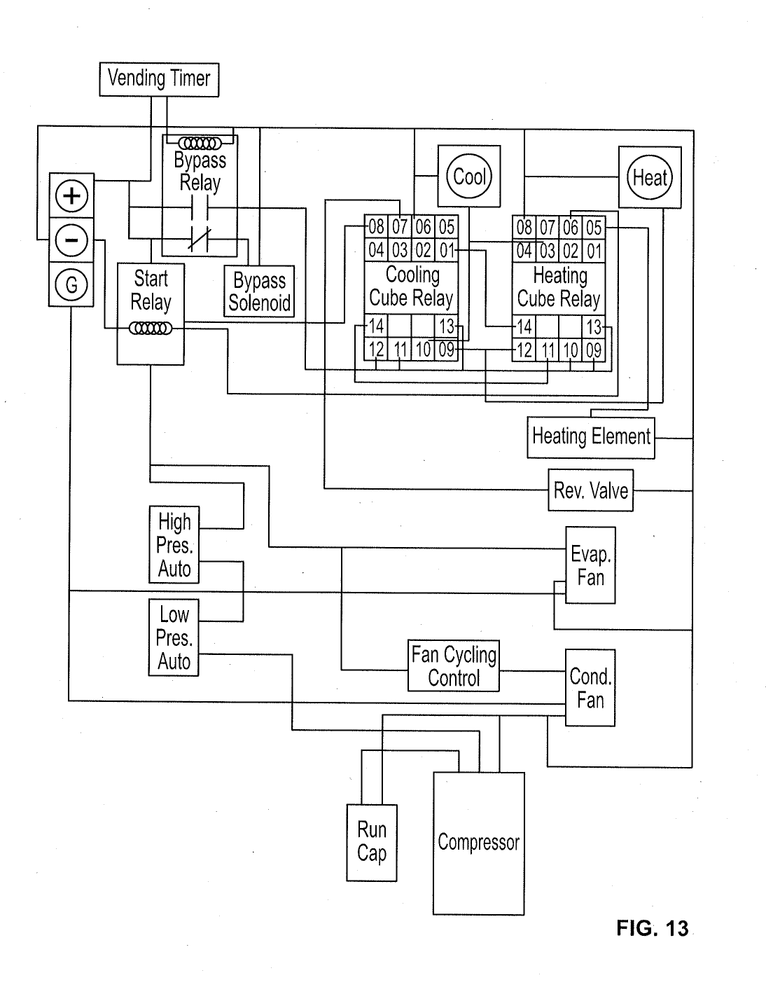

Device 31 also generally includes user controls on user console 42 and at least one display monitor 44. In the exemplary implementation of FIG. 4, the controls associated with user console 42 include a first push button 47 to engage the cooling function (see FIG. 11) and set the flow of refrigerant in cooling and/or heating system 90, e.g., the exemplary system 90 illustrated in FIGS. 8 and 9. A second push button 48 may be selected to engage the heating cycle (see FIG. 12). In exemplary implementations of the present disclosure, operation of cooling and/or heating system 90 interacts with the noted controls, i.e., through appropriate wiring/communication protocols, e.g., exemplary wiring diagram of FIG. 13. Indicia may be provided in conjunction with user console 42 (e.g., “Cool down” for first push button 47 and “Warm up” for second push button 48) to guide user interaction therewith. While separate push buttons 47 and 48 are provided in this exemplary embodiment, it is well within the scope of the invention to utilize a dial or mode switch to control the mode of operation, thereby allowing a user to select a cool or warm air flow as shown, for example, by control/display 28 in FIG. 3.

In exemplary implementations of the present disclosure, a vending section or module 49 is mounted with respect to housing 32. Vending module 49 is typically adapted to receive coins, tokens, currency, and/or credit/debit cards, thereby permitting a user to activate device 31 to deliver cooled and/or heated airflow. As noted with reference to the embodiment of FIGS. 1-3, the vending section/module 49 is generally programmed to control operation of the heating and/or cooling functionality to a predetermined period of time for a predetermined payment. Of note, the correlation between payment and airflow delivery may be subject to periodic change/adjustment, e.g., to address pricing changes, marketing and/or promotional activities, and the like. In addition, vending module 49 may be linked to operation of ancillary features and/or functions of the disclosed system/unit, e.g., Internet or information access and/or display, massage functionality, aroma therapy, scented airflow, music delivery, photographic and/or videographic functionality, and/or food/beverage delivery. Alternatively, one or more additional vending modules may be associated with housing 32 (or separately mounted/positioned), e.g., to interact with ancillary features and/or functions as described herein.

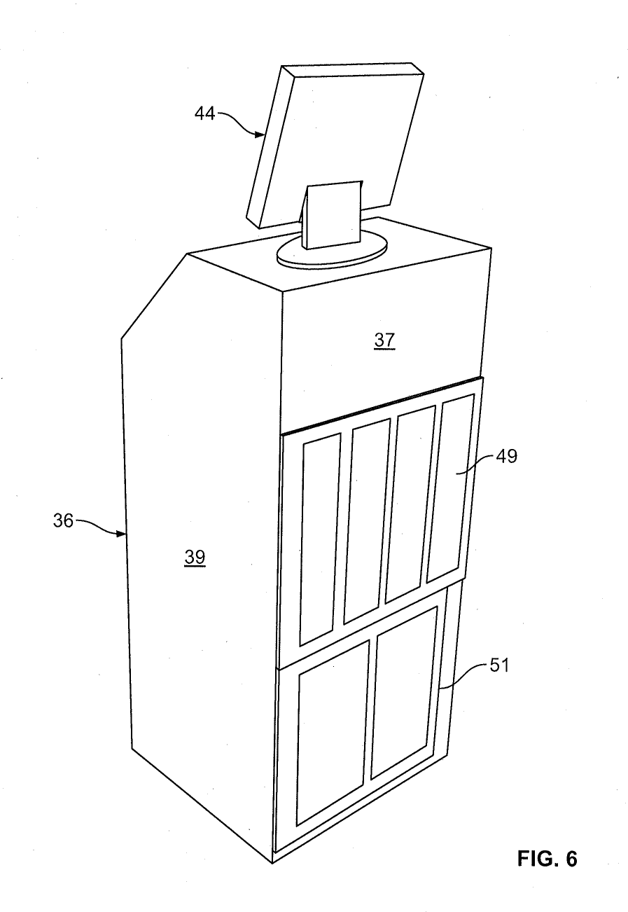

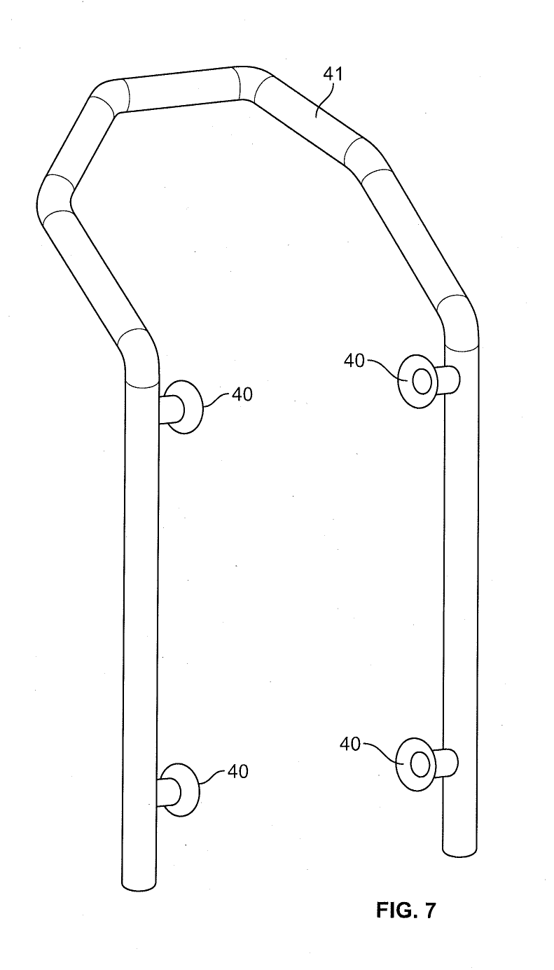

FIG. 5 shows housing 32 with a detachable portion (not pictured) removed from the front side 36 thereof. Removal of such detachable portion allows access to the interior region 91 of housing 32, e.g., to access and maintain the cooling and/or heating equipment to be positioned therewithin. As shown in FIG. 5, housing 32 includes exemplary console 32 and display monitor 44, but does not include vending module 49. The schematic depiction of FIG. 5 illustrates the modularity of exemplary implementations of the disclosed system/method. For example, vending module 49 may be separately supplied and mounted with respect to housing 32, as would be readily apparent to persons skilled in the art. FIG. 6 is a rear view of housing 32 of device 31 showing an exemplary location for an upper evaporator air intake vent 49 and a lower exhaust air vent 51. FIG. 7 is a perspective view of an illustrative one-piece handle 41 with four (4) brackets 40 for mounting with respect to housing 32, e.g., for mounting to left side 38 and right side 39 of housing 32. As previously noted, handle 41 may take various forms and geometries, and may be supplied in an integral and/or segmented form. In addition, handle 41 may be encased, in whole or in part, in a desired material, e.g., a foam material, to facilitate user interaction and comfort.

Turning to FIGS. 8 and 9, an exemplary cooling and heating system 90 is schematically depicted in position within interior region 91 of housing 32. The exemplary system 90 depicted in FIGS. 8 and 9 supports the delivery of both cooled and heated air to system users, i.e., through air diffusers 46. However, as described herein, the present disclosure is not limited by or to systems that are designed to deliver both cooled and heated air. Rather, exemplary cooling and heating system 90 (as schematically depicted in FIGS. 8 and 9) may be replaced with a system that only offers cooling, or a system that only offers heating, or an alternative system for offering both cooling and heating, without departing from the spirit or scope of the present disclosure.

As shown in FIGS. 8 and 9, housing 32 defines a frame base 43 upon which certain elements associated with cooling and heating system 90 are positioned/mounted. As shown in FIGS. 8 and 9 (and also schematically illustrated in FIG. 11 (cooling mode) and FIG. 12 (heating mode)), exemplary cooling and heating system 90 includes a compressor 52 positioned on frame base 43 adjacent to and in communication with condenser 53 and a condenser fan 54. An evaporator 56 is positioned above condenser 53 and a fan control unit 99 is generally provided. A cooling thermal expansion valve 95 (FIGS. 9 and 11) is located between condenser 53 and evaporator 56 as in a conventional home air conditioner unit. Condenser 53 may be provided with a high pressure protection switch 98. An accumulator 58 is also positioned on frame base 43 and is disposed at the inlet side of compressor 52 between a reversing valve 59 and compressor 52, the accumulator functioning (as part of the overall system) to allow exemplary cooling and heating system 90 to operate in both a cooling and heating cycle.

In order to facilitate the dual cooling/heating operation of exemplary cooling and heating system 90, in cooling mode (FIG. 11), a refrigerant is allowed to flow to evaporator 56 through cooling thermal expansion valve 95 (through check valves 92). Of note, thermal expansion valve 95 is of conventional design and is generally located at the cooling coil of evaporator 56 for connection between an incoming refrigerant line and the refrigerant inlet to the cooling coil. Cooling thermal expansion valve 95 maintains the pressure difference (high and low) at the entry point to the cooling coil, thus assuring that as the high-pressure refrigerant enters the low pressure space of the cooling coil, it can “evaporate” from a refrigerant liquid to a gaseous form, thus producing the temperature drop that cools the cooling coil itself. More particularly, liquid refrigerant metered into the evaporator coil 56 through cooling thermal expansion valve 95 converts to a gas as it flows through the evaporator coil 56, such that the refrigerant is in a low-pressure, low temperature gaseous state when it reaches the end of the evaporator coil 56. This low pressure, low temperature refrigerant gas is drawn back into compressor 52 via the suction line connecting the outlet of evaporator coil 56—by way of accumulator 57—to the inlet port of compressor 52.

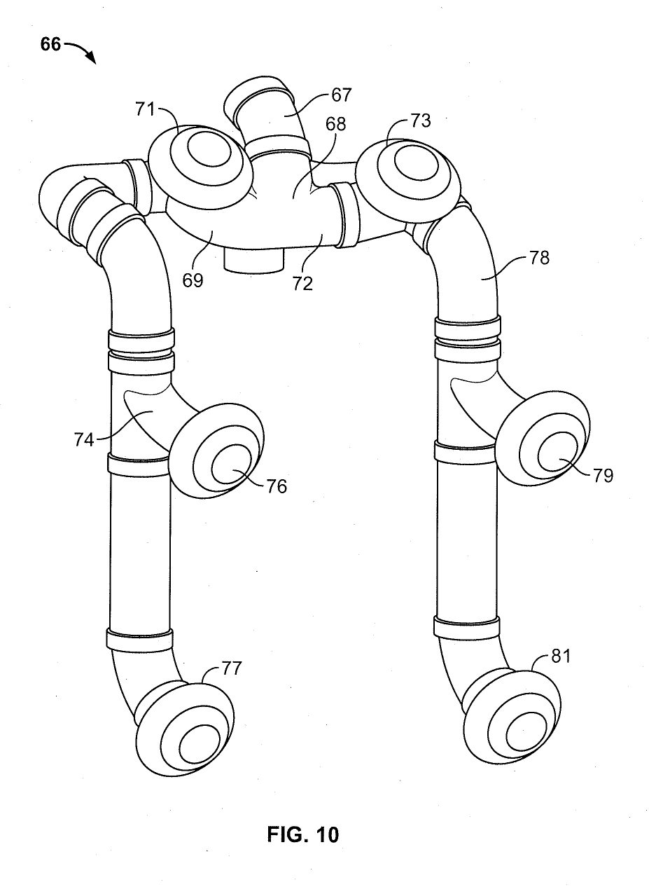

Thus, when cooling and heating system 90 is operating in a cooling mode (FIG. 11), heat is dissipated away from evaporator 56 by a fan or blower 62 with a motor 63 and a run capacitor 64 (FIG. 9). Cool air is directed to a user through an exemplary duct system 66 as shown in FIG. 10, such duct system 66 directing cooled airflow to and through diffusers 46. Blower 62 is positioned at evaporator 56 to force the air cooled by evaporator 56 through duct system 66 to a user positioned in region 33, i.e., adjacent the front side 36 of housing 31.

With further reference to FIG. 10, exemplary duct system 66 includes a central manifold 67 that is adapted to be connected to or otherwise in communication with the outlet of blower 62. A front upper duct section 68 is in communication with manifold 67 and includes a left vent arm 69 to feed a left upper air vent 71 and a right upper duct arm 72 to feed a right upper vent 73. Air vents 71 and 73 communicate with air diffusers 46 so as to deliver airflow to a system user. Indeed, the air vents 71 and 73 may function as diffusers 46, e.g., by providing airflow communication from the interior region 91 of housing 31 through the front side 36 so as to enter region 33. Exemplary duct system 66 also includes a left duct leg 74 that extends downward and includes an upper vent 76 and terminates at a lower vent 77. Similarly, exemplary duct system 66 includes a right duct leg 78 that extends downward and includes an upper vent 79 and terminates at a lower vent 81. Vents 76, 77, 79 and 81 may advantageously communicate with or function as diffusers 46 so as to deliver airflow to region 33, as described herein.

For the exemplary cooling and heating system 90 disclosed herein, reversing valve 59 advantageously allows for delivery of both cooled and heated airflow to region 33 through the same exemplary duct system 66. The dual cooling/heating operation of exemplary cooling and heating system 90 requires refrigerant to flow in a reverse direction when in heating mode (FIG. 12) as compared to when operating in cooling mode (FIG. 11). Thus, when in heating mode, refrigerant flow bypasses cooling thermal expansion valve 95. Instead, refrigerant flow is through evaporator 56 which acts as a condenser for the compressed refrigerant, making available heat energy for delivery to duct system 66. Thus, evaporator 56 essentially acts as a condenser and gives out heat energy for delivery to system users. The heat is transferred to the air that blows across the coil of evaporator 56 and the heated air is ducted to diffusers 46. The liquid refrigerant bypasses cooling thermal expansion valve 95 and flows to heating thermal expansion valve 81 where it expands, thereby entering the vapor state and absorbing heat from the outside/ambient air, before returning to accumulator 57 and compressor 52. In exemplary embodiments of the present disclosure, heating thermal expansion valve 81 operates in conjunction with bulb 97 that monitors temperatures in the refrigerant line and assists in regulating refrigerant flow.

Thus, as noted herein, when operating in the heating mode (FIG. 12), heated air is directed towards a user by blower 62 and blower motor 63 to duct manifold 67. In order to accelerate the operation of the heating mode, an electric heating element 84 may be optionally positioned at blower 62. Heating element 84 may be energized when a user selects the heating mode of operation in order to raise the temperature of air forced by blower 62 towards a user.

With specific reference to FIGS. 11 and 12, refrigerant flow in cooling mode (FIG. 11) and heating mode (FIG. 12) are schematically depicted. FIG. 11 shows refrigerant flow when exemplary cooling and heating system 90 is in the cooling cycle or cooling mode, with operative elements components schematically depicted in association with such refrigerant flow. Generally, in the cooling cycle/mode, refrigerant is compressed by compressor 52 and flows through reversing valve 59 and condenser 53 to cooling thermal expansion valve 95 and evaporator 56. Low pressure refrigerant then flows through accumulator 57 and returns to compressor 52 to repeat the cycle. The fan associated with blower 62 is positioned adjacent to the cooling coils of evaporator 56 to blow cooled air into duct manifold 67.

When a user selects the heating mode, refrigerant flow is generally depicted in the schematic illustration of FIG. 12. In particular, the position of reversing valve 59 is reversed so as to reverse the flow of refrigerant relative to the cooling cycle/mode that is schematically illustrated in FIG. 11. Thus, refrigerant flow from compressor 52 flows through evaporator 56 and to heating thermal expansion valve 81. Heated air surrounding evaporator 56 is forced into duct manifold 63 by blower 62, thereby providing user with the selected warm air relief. The detailed flow chart is shown in FIG. 12. Electric heating element 84 may be energized to generate additional heated air quickly that may also be forced into duct manifold 67 by the fan motor 63 and blower 62 for distribution to the user through diffusers 46.

As noted herein, FIG. 13 provides an illustrative schematic diagram of electrical wiring that may be employed in an exemplary cooling and/or heating system 90 to provide cooling and/or heating functionality, as described herein. Operation of the such electrical system may be advantageously electrically linked to a vending module 49. Exemplary operative steps and/or operations associated with exemplary cooling and/or heating systems 90 according to the present disclosure are described with reference to the following example. However, it is to be expressly understood that the present disclosure is not limited by or to such example.

### Example 1

Operation of the control circuit shown in FIG. 13 for exemplary cooling and heating system 90 is as follows. The end user activates the vending mechanism 49, e.g., by providing a payment to vending module 49 (e.g., coins/dollar bills, credit/debit card, voucher, etc.):
The vending mechanism transfers power to the bypass relay which functions to:
   Break power to the bypass solenoid
   Energize the heating and/or cooling circuits
      If the user selects cooling mode, e.g., using controls associated with console panel 20:
The user pushes the cooling button, temporarily closing the circuit to energize the cooling relay.
Once the cooling relay is energized, it transfers power to:
   The reversing valve to allow operation in cooling mode
   The start relay, allowing power to flow to the evaporator fan, condenser fan, and compressor
Operating like an air conditioning unit through the cooling cycle, e.g., as schematically depicted in FIG. 11.
   If the user selects heating mode, e.g., using controls associated with console panel 20:
The user pushes the heating button, temporarily closing the circuit to energize the heating relay.
Once the heating relay is energized it transfers power to:
   The reversing valve to allow operation in heating mode
   The electric heating element (optional) to boost the heating air temperature.
   The start relay, allowing power to flow to the evaporator fan, condenser fan, and compressor.
   Operating like a heat pump through a heating cycle, e.g., as schematically depicted in FIG. 12.

Once a user has selected the desired operation of an exemplary implementation of the present disclosure that supports both cooling and heating, i.e., the user selects cooling or heating mode, the disclosed system continues to run in that mode until the vending mechanism has broken the power supply to the bypass relay. Once the relay is no longer energized, it will energize the bypass solenoid to allow the system to equalize pressure quickly. By equalizing the pressures rapidly, the system can be operated in a different mode as compared to the last user selection without delay.

Heating and/or cooling system 90 can be powered by various energy sources, e.g., water, electric, fuel, oil, gas, solar, geothermal, propane, flex fuel, diesel, battery power, chilled water coil and any other energy source. When powered by solar energy, the disclosed system 90 may be supplied with energy from solar energy collectors regardless of the location of system 90 or the source of the solar power. Excessive solar energy may be resold or bartered with the utility host provider. Additionally, condensate formed during operation of system 90 may conveniently be collected and removed from system 90, e.g., by a condensate port. The condensate may be used for various purposes, e.g., irrigation at an outdoor venue.

It can readily be seen that the cooling and/or heating system constructed in accordance with the invention can be easily installed in a populated public location, such as a beach, city street, or park or a venue, such as a theme park, golf course, concert, ski slope or other sports venue and indoor locations such as subway stations, night clubs, college bars and airports.

It will thus be seen that the objects set forth above, among those made apparent from the preceding description, are efficiently attained and, since certain changes may be made in the disclosed system/method set forth herein without departing from the spirit and/or scope of the invention, it is intended that all matters contained in the above description and shown in the accompanying drawings shall be interpreted as illustrative and not in a limiting sense. It is also to be understood that the following claims are intended to cover all of the generic and specific features of the invention herein described.

1. A system for delivering airflow at a modified temperature relative to ambient conditions, comprising:
a housing defining an enclosed region;
at least one unit for modifying the temperature of ambient air that is positioned at least in part within the enclosed region;
an airflow delivery system that cooperates with the at least one unit to deliver airflow at a modified temperature to a user positioned external to the housing;
a user control associated with the housing and in operative communication with the at least one unit, the user control being adapted to activate delivery of airflow at a modified temperature to the user; and
a vending module mounted with respect to the housing for controlling operation of the at least one unit.

2. The system of claim 1, further including a display mounted with respect to the housing for displaying information for viewing by a user.

3. The system of claim 2, wherein the displayed information is selected from the group consisting of advertising information, promotional information, video-based media, information accessed from a website over a network, and combinations thereof.

4. The system of claim 1, wherein the at least one unit is adapted to deliver airflow that is cooled relative to ambient conditions, airflow that is heated relative to ambient conditions, or airflow that is either cooled or heated relative to ambient conditions.

5. The system of claim 4, wherein the at least one unit is adapted to deliver airflow that is either cooled or heated relative to ambient conditions, and wherein the user control is adapted to select a desired mode of operation as between delivering airflow that is cooled relative to ambient conditions and airflow that is heated relative to ambient conditions.

6. The system of claim 1, wherein the user control is associated with a console that is mounted or otherwise associated with the housing.

7. The system of claim 1, wherein the airflow delivery system includes ductwork positioned at least in part within the enclosed region of the housing.

8. The system of claim 1, wherein the airflow delivery system includes one or more diffusers for delivery of airflow at a modified temperature to the user.

9. The system of claim 1, further comprising an area external to the enclosed region of the housing, said external area being at least in part bounded for retention of airflow delivered at a modified temperature.

10. The system of claim 9, wherein the external area is bounded at least in part by one or more bounding elements selected from the group consisting of a seating area, wall, ceiling, panel, curtain, canopy, tent and combinations thereof.

11. The system of claim 1, wherein the airflow delivery system includes extended ducting that extends away from the housing and that is adapted for directing airflow as desired by the user.

12. The system of claim 1, wherein the user control permits the user tone or more airflow parameters.

13. The system of claim 1, further comprising an airflow augmentation mechanism selected from the group consisting of a source of aroma therapy, a source of scent, an ionization unit, an airflow filtration unit, and combinations thereof.

14. The system of claim 1, further comprising transportation means that permits the housing to be portably repositioned.

15. (canceled)

16. (canceled)

17. The system of claim 1, further comprising functionality for delivering at least one of food and beverage in association with the housing.

18. The system of claim 1, further comprising functionality for generating one or more photographs in association with the housing.

19. The system of claim 1, further comprising one or more of the following ancillary features or functions: (i) LED lighting or other illumination for visibility at night; (ii) handicap accessibility; (iii) one or more steps; hand rails; seating areas; canopies; curtains; ceilings; walls; or doors; (iv) vent and return air functionality that supports a desired airflow pattern; (v) one or more advertising display screens attached or mounted with respect to the housing; and (vi) audio functionality.

20. The system of claim 1, wherein the at least one unit includes:
a refrigerant flow system that includes a compressor for pressurizing refrigeration; a condenser; a reversing valve; an evaporator; a blower; a heating thermal expansion valve; and a cooling thermal expansion valve;
wherein the refrigerant flow system is adapted to deliver airflow that is both cooled relative to the temperature of ambient air and heated relative to the temperature of ambient air.

21. The system of claim 20, further comprising a heating element for providing additional heated air to the user.

22. The system of claim 1, wherein the airflow delivery system includes ductwork; a duct manifold that communicates with one or more vent arms and; one or more duct legs to communicate with airflow outlets for delivery of airflow to the user.

23. The system of claim 1, further comprising at least one handle mounted with respect to the housing.

24. The system of claim 1, further comprising a condensation port for removal of condensate formed by operation of the at least one unit.

25. A method of providing environmental relief to an individual, comprising;
providing a system that is adapted to modify the temperature of ambient air and deliver an airflow at said modified temperature to one or more locations;
providing a vending module in conjunction with said system;
initiating operation of the system at least in part based on interaction with the vending module to modify said temperature of ambient air and deliver said airflow at said modified temperature to one or more locations; and
positioning said individual in an airflow path of said delivered airflow at least one of said one or more locations.

26. The method of claim 25, wherein interaction with said vending module includes processing a payment through said vending module.

27. The method of claim 25, further comprising:
providing a display mounted with respect to said system, and
delivering at least one image to said display for viewing by said individual when said individual is positioned in said airflow path.

28. The method of claim 27, wherein said at least one image is selected from the group consisting of advertising information, promotional information, video-based media, information accessed from a website over a network, and combinations thereof.

29. The method of claim 25, wherein said system is adapted to deliver airflow that is cooled relative to ambient conditions, airflow that is heated relative to ambient conditions, or airflow that is either cooled or heated relative to ambient conditions.

30. The method of claim 29, further comprising:
selecting either a cooled airflow or a heated airflow for delivery to said one or more locations.

31. The method of claim 29, wherein said system includes control functionality that is adapted to allow an individual to select from between said cooled airflow and said heated airflow.

32. The method of claim 25, wherein said system includes ductwork that is adapted to deliver said airflow to said one or more locations.

33. The method of claim 32, wherein said ductwork communicates with one or more diffusers.

34. The method of claim 25, wherein said one or more positions are bounded at least in part for retention of airflow delivered at said modified temperature.

35. The method of claim 34, wherein said bounding is provided at least in part by one or more bounding elements selected from the group consisting of a seating area, wall, ceiling, panel, curtain, canopy, tent and combinations thereof.

36. The method of claim 25, further comprising:
providing an airflow augmentation mechanism that is adapted to augment the airflow, said augmentation mechanism selected from the group consisting of a source of aroma therapy, a source of scent, an ionization unit, an airflow filtration unit, and combinations thereof.

37. The method of claim 25, wherein said system includes a refrigerant flow system that includes a compressor for pressurizing refrigeration; a condenser; a reversing valve; an evaporator; a blower; a heating thermal expansion valve;
and a cooling, thermal expansion valve; and wherein the refrigerant flow system is adapted to deliver airflow that is both cooled relative to the temperature of ambient air and heated relative to the temperature of ambient air.

38. (canceled)

39. (canceled)

40. (canceled)

41. (canceled)
